(19) United States
(12) Patent Application Publication
(10) Pub. No.: US 2012/0045052 A1
(43) Pub. Date: Feb. 23, 2012

(54) Theft deterrence of motion picture films employing damaged-video files

(76) Inventors: Pedro Javier Vazquez, (US); Kucherenko Danylo, Petrozavodsk (RU)

(21) Appl. No.: 13/211,357

(22) Filed: Aug. 17, 2011

Related U.S. Application Data
(60) Provisional application No. 61/374,604, filed on Aug. 17, 2010.

(51) Int. Cl. H04N 7/167

(52) U.S. Cl. 380/201

(57) ABSTRACT

A method and apparatus for deterrence of the theft of video files is described. A partial file is downloaded such that it does not contain all of the necessary information to run the file. When a user wants to purchase the file, the difference between the working and non-working file is downloaded to the user. A randomized and watermark overlaid on the file. The watermark is unique to the purchased file, so that if anyone attempts to illegally copy it, both the fact that the file is illegally copied and the user who owned the file legally can be determined.

### CROSS-REFERENCE TO RELATED APPLICATIONS

This application claims the benefit of U.S. Provisional Application No. 61/374,604, filed 17-AUG-2010, which is hereby incorporated by reference herein.

### TECHNICAL FIELD

In the field of image analysis, a method and apparatus are disclosed for the deterrence of illegal sharing and downloading of motion picture films and other electronic video files on a network using automated file alteration, pattern analysis and restoration for legitimate users.

### BACKGROUND ART

Unauthorized file sharing is a serious issue on public networks. One person may obtain a file legally from an originator, but then send it to multiple users who were not authorized to receive it by the originator. Thus, the originator of the file, who may charge for use of the file, or may want the file to remain secure, has no recourse, unless a search turns up the file on a site that he did not authorize.

One common protocol for file sharing is BITTORRENT, which is a peer-to-peer file sharing protocol used for distributing large amounts of data. BITTORRENT is one of the most common protocols for transferring large files, and it has been estimated that it accounts for roughly 27-55% of all Internet traffic (depending on geographical location) as of February 2009.

The BITTORRENT protocol allows users to distribute large amounts of data without the heavy demands on their computers that would be needed for standard Internet hosting. A standard host's servers can easily be brought to a halt if high levels of simultaneous data flow are reached. The protocol works as an alternative data distribution method that makes even small computers (e.g. mobile phones) with low bandwidth capable of participating in large data transfers.

First, a user playing the role of file-provider makes a file available to the network. This first user's file is called a seed and its availability on the network allows other users, called peers, to connect and begin to download the seed file. As new peers connect to the network and request the same file, their computer receives a different piece of the data from the seed. Once multiple peers have multiple pieces of the seed, BITTORRENT allows each to become a source for that portion of the file. The effect of this is to take on a small part of the task and relieve the initial user, distributing the file download task among the seed and many peers. With BITTORRENT, no one computer needs to supply data in quantities that could jeopardize the task by overwhelming its resources, yet the same final desired result occurs in that each peer receives the entire file.

After the file is successfully and completely downloaded by a given peer, the peer is able to shift roles and become an additional seed, helping the remaining peers to receive the entire file. This eventual shift from peers to seeders determines the overall ‘health’ of the file (as determined by the number of alternative sources from which a file is available in its complete form).

This distributed nature of BITTORRENT leads to a swarm-like spreading of a file throughout peers. As more peers join the swarm, the likelihood of a successful download increases. Relative to standard Internet hosting, this provides a significant reduction in the original distributor's hardware and bandwidth resource costs. It also provides redundancy against system problems, reduces dependence on the original distributor and provides a source for the file, which is generally temporary and therefore harder to trace than when provided by the enduring availability of a host in standard file distribution techniques.

A BITTORRENT client is any program that implements the BITTORRENT protocol. Each client is capable of preparing, requesting, and transmitting any type of computer file over a network, using the protocol. A peer is any computer running an instance of a client.

To share a file or group of files, a peer first creates a small file designated a “torrent” (e.g. MyFile.torrent). This file contains metadata about the files to be shared and about the tracker, the computer that coordinates the file distribution. Peers that want to download the file must first obtain a torrent file for it and connect to the specified tracker, which tells them from which other peers to download the pieces of the file.

Though both ultimately transfer files over a network, a BITTORRENT download differs from a classic download (as is typical with an HTTP or FTP request, for example) in several fundamental ways. First, BITTORRENT makes many small data requests over different TCP connections to different machines, while classic downloading is typically made via a single TCP connection to a single machine. Second, BITTORRENT downloads in a random or in a “rarest-first” approach that ensures high availability, while classic downloads are sequential.

Taken together, these differences allow BITTORRENT to achieve much lower cost to the content provider, much higher redundancy, and much greater resistance to abuse or to “flash crowds” than regular server software. However, this protection, theoretically, comes at a cost: downloads can take time to rise to full speed because it may take time for enough peer connections to be established, and it may take time for a node to receive sufficient data to become an effective uploader. This contrasts with regular downloads (such as from an HTTP server, for example) that, while more vulnerable to overload and abuse, rise to full speed very quickly and maintain this speed throughout.

The peer distributing a data file treats the file as a number of identically sized pieces, usually with byte sizes of a power of 2, and typically between 32 KB and 4 MB each. The peer creates a hash for each piece, using the SHA-1 hash function, and records it in the torrent file. Pieces with sizes greater than 512 KB will reduce the size of a torrent file for a very large payload, but is claimed to reduce the efficiency of the protocol. When another peer later receives a particular piece, the hash of the piece is compared to the recorded hash to test that the piece is error-free. Peers that provide a complete file are called seeders, and the peer providing the initial copy is called the initial seeder.

The exact information contained in the torrent file depends on the version of the BITTORRENT protocol. By convention, the name of a torrent file has the suffix .torrent. Torrent files have an “announce” section, which specifies the URL of the tracker, and an “info” section, containing (suggested) names for the files, their lengths, the piece length used, and a SHA-1 hash code for each piece, all of which are used by clients to verify the integrity of the data they receive.

### SUMMARY OF INVENTION

A method and apparatus for deterring the theft of video files or movies is described.

Incident to using the method, a partial or damaged-video file is previously downloaded by a user. The damaged-video file is not operable to play the movie, but a key can be purchased to make it playable. When a user wants to purchase the movie, a key containing the difference between a working movie and the damaged video is created and downloaded to the user. The working move includes a watermark that is unique to the user and purchased file, so that if anyone attempts to illegally copy it, both the fact that the file is illegally copied and the user who owned the file legally can be determined.

The method is applied to operable movies in electronic format, also referred to as video files. The method includes steps of detecting keyframes in the movie; producing a damaged-video file by removing a first portion of the bytes arbitrarily selected from keyframes to make the keyframes unreadable by a video player; inserting a watermark at a randomized location on the video file to create a watermarked-movie file; creating a key used to restore the damaged-video file to the watermarked-movie file; and sending the key to a user so that the user can restore the damaged-video file to the watermarked-movie file. The keyframes from which the bytes are removed may be randomly selected, or all of the keyframes may be selected.

Damaged copies of the movie are made widely available to the public preferably by users, also called peers, who have agreed to permit others to download the damaged movies from their computers. When a user decides to purchase a key to restore a damaged copy of the movie, he requests a key from a seller. The seller then initiates the watermarking of the movie and creation of the key, which is essentially a file containing the difference between the damaged-video file already in possession of the user and the operable watermarked file. Either the key is a data file used by a decrypting module to restore the damaged video to an operable file, or the key is itself a fully independent program run on the user's computer that uses the difference to produce a viewable movie.

An apparatus or system for implementing the method may include a processing server or computer connected to a network that receives requests from a seller for a key. A re-encode module that is coupled to the computer, optionally decompresses the original movie; extracts the audio component of the movie to a separate file; detects keyframes; and when the movie is decompressed, it recompresses the movie absent the audio portion. A key generation module that is also coupled to the computer, inserts a watermarks at randomized locations on the recompressed movie. It also creates a key usable to restore the damaged-video file to the watermarked-movie file. A damaging video module that is coupled to the computer, removes bytes arbitrarily selected from keyframes in the recompressed movie.

### Technical Problem

Movies in electronic form have no viable means for detecting who lawfully purchased the movie and who possesses a stolen or unauthorized copy of the movie. A method is needed to enable free distribution of a movie file to potentially millions of potential users, to discourage illicit sharing of operable movies, and to ensure that only those who actually pay for the movie are enabled to play or watch the movie. Also, the method should enable the user to employ a technique that is fast and of minimal inconvenience once the user decides to make a purchase.

### Solution to Problem

The solution is to distribute damaged, or unplayable, copies of the movie and enable the user to purchase a key to identify the purchaser and to make the movie available for full-featured playback.

### Advantageous Effects of Invention

The method enables use of a distributed system for downloading movies. Internet traffic in downloading the damaged movie can be distributed among a broad base of users holding the damaged copy for free downloading by anyone who wants it. This eliminates choke points on any particular server. When a user pays for the movie, a key is provided that restores the damaged movie to operable condition and marks it to show that it belongs to that user. The key can be downloaded very quickly as it is very much smaller in byte size than the actual movie. If the restored movie is illicitly copied, the user who originally bought the movie is instantly identifiable, which discourages knowingly making illicit copies.

### BRIEF DESCRIPTION OF DRAWINGS

The drawings illustrate preferred embodiments of the device and method disclosed herein and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a block diagram illustrating digital file processing steps.

FIG. 2 illustrates steps in an embodiment of the method for deterring theft of a video file.

FIG. 3 illustrates relationships of frames to keyframes.

FIG. 4 illustrates the selection of frames to watermark.

FIG. 5 illustrates the addition of new keyframes to a video file.

FIG. 6 illustrates the hardware that is preferably involved in an embodiment of the method for deterring theft of a video file.

FIG. 7 illustrates peer distribution networking that may be used with an embodiment of the method for deterring theft of a video file.

FIG. 8 illustrates user computer and Internet store interactions in an embodiment of the method for deterring theft of a video file.

FIG. 9 illustrates key generation and user action to restore the damaged-video file to operability using the key.

FIG. 10 illustrates a processing server, original movie handling and interactions with an Internet-store server once a key is ordered.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. For example, the steps in the method of the invention may be performed in any order that results the use of a damaged-video file for deterring theft of a video file.

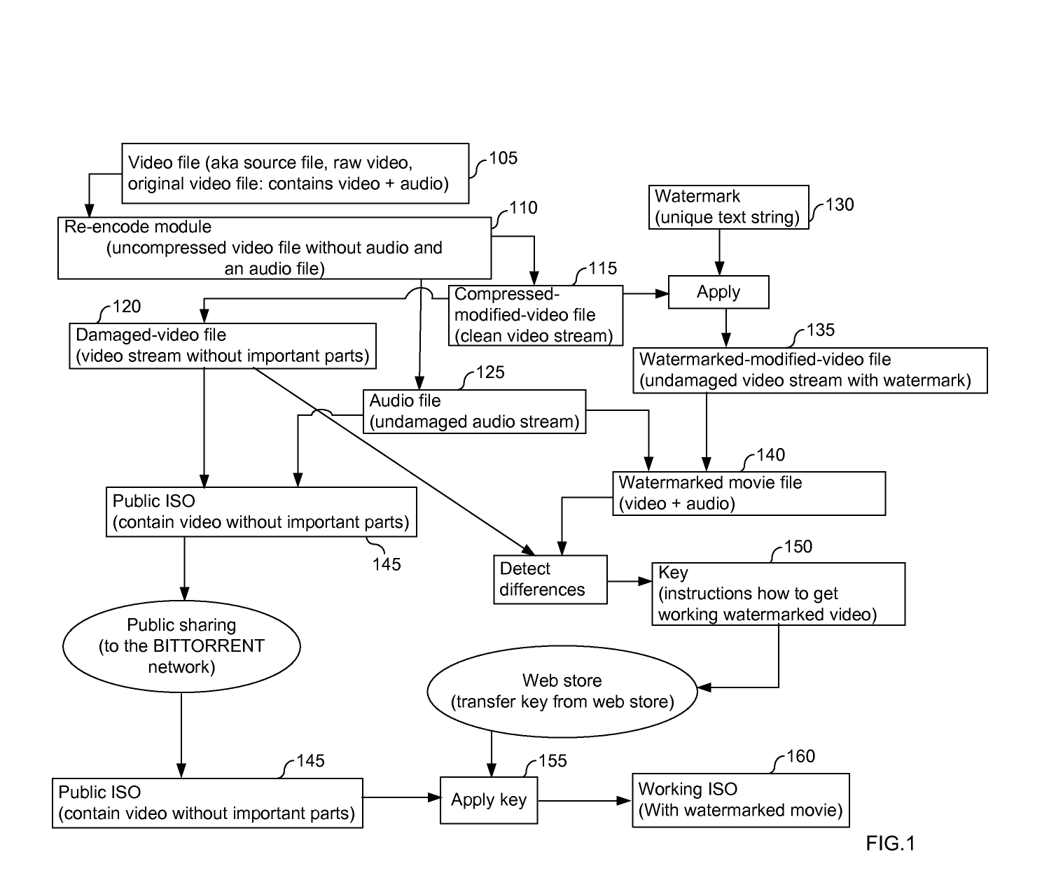

FIG. 1 diagrams steps in embodiments of the method for deterring theft of a video file. A video file (105), also referred to herein as a source file, a raw video and an original video, is an electronic movie comprising moving images in the form of bytes of data and often, although not always, the images are linked with an audio component or synchronized sound. The video file is an electronic video file in a state prior to being acted upon by the method or system described herein. The video file may be described as including bytes of data organized in a video stream and an audio stream. The video stream includes “keyframes” and “frames,” and the audio stream includes “frames.” The video file may also be described as presenting moving images stored as bytes of data representing a sequence of static images organized in keyframes and frames.

A video file is commonly stored on an optical disc, which uses an optical disc storage media format. (International Organization for Standardization). This is referred to herein as a public ISO and ISO image, where public refers to an un-encrypted standard open for use by the public. The ISO image which is also known as a disc image of the optical disc. A feature of an ISO image is that it can be easily rendered, or “burned,” to a CD (compact disc), a DVD (Digital Versatile Disc), or a BD (BLU-RAY Disc) by using media authoring or disc burning software typically found on modern home and business computers or easily purchased from many software vendors. Commonly, movies are burned to DVDs.

The disc image is composed of the data contents of every written sector of an optical disc, including the optical disc file system. ISO images can be created from optical discs, or can be used to recreate optical discs using software.

In a minimum embodiment including the least number of steps of the method, the method includes steps of: producing a damaged-video file (120) by implementing an action comprising removing a portion of the bytes from the video file to make the video file (105) unplayable; inserting a watermark (130) at a randomized location on the video file (105) to create a watermarked-movie file (140); creating a key (150) used to restore the damaged-video file (120) to the watermarked-movie file (140), said key (150) comprising the difference between the watermarked-movie file (140) and the damaged-video file (120); and sending the key (150) to a user so that the user can restore the damaged-video file (120) to the watermarked-movie file (140). The keyframes from which the bytes are removed may be randomly selected, or all of the keyframes may be selected.

In an alternative embodiment to the minimum embodiment, the first step is changed to use encryption to produce the damage-video file (120) instead of “removing a portion of the bytes.” This step would then read “producing a damaged-video file by implementing an action comprising encrypting the video file to make the video file unplayable.”

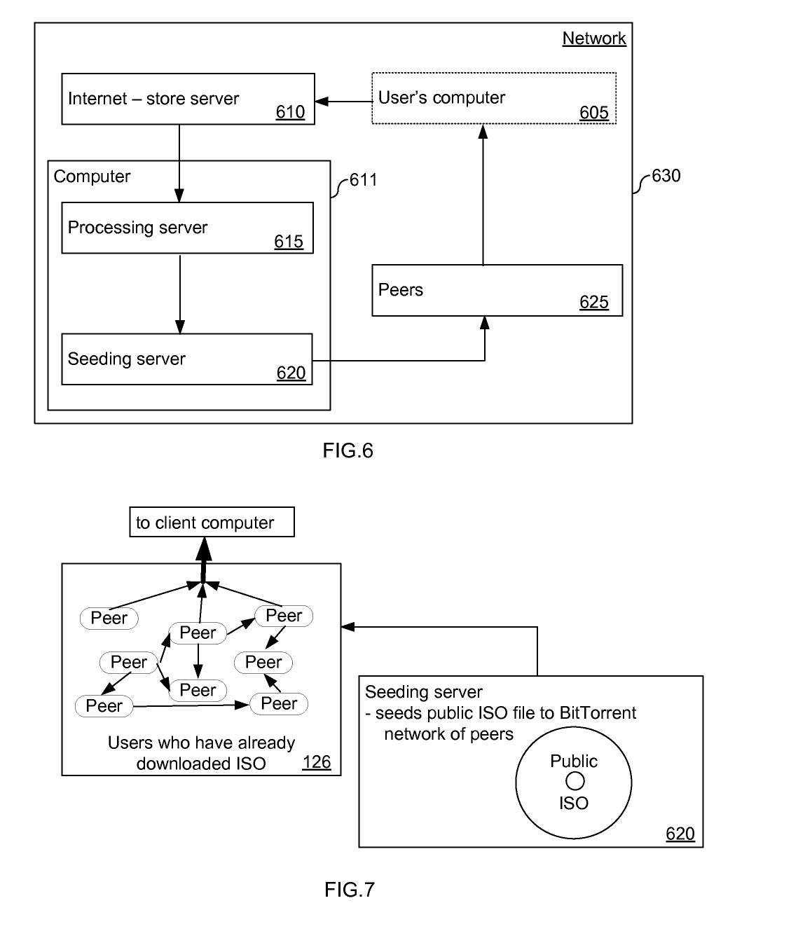

FIG. 6 shows an overview of components used in several embodiments of the method and the peripheral components interacting with the computer. The method is performed on computer (611) coupled to a network (630). The computer has a storage medium (1030), which is a non-transitory computer readable storage medium, such as a hard drive. The peripheral components interacting with the computer (611) include a user's computer (605); an Internet—store server (610), which sells the keys to unlock the damaged videos; and peers (625), which distribute damaged videos. The computer (611) may be a single computer or preferably a combination of networked servers including a processing server (615) and a seeding server (620). There are preferably multiple processing and seeding servers in the system.

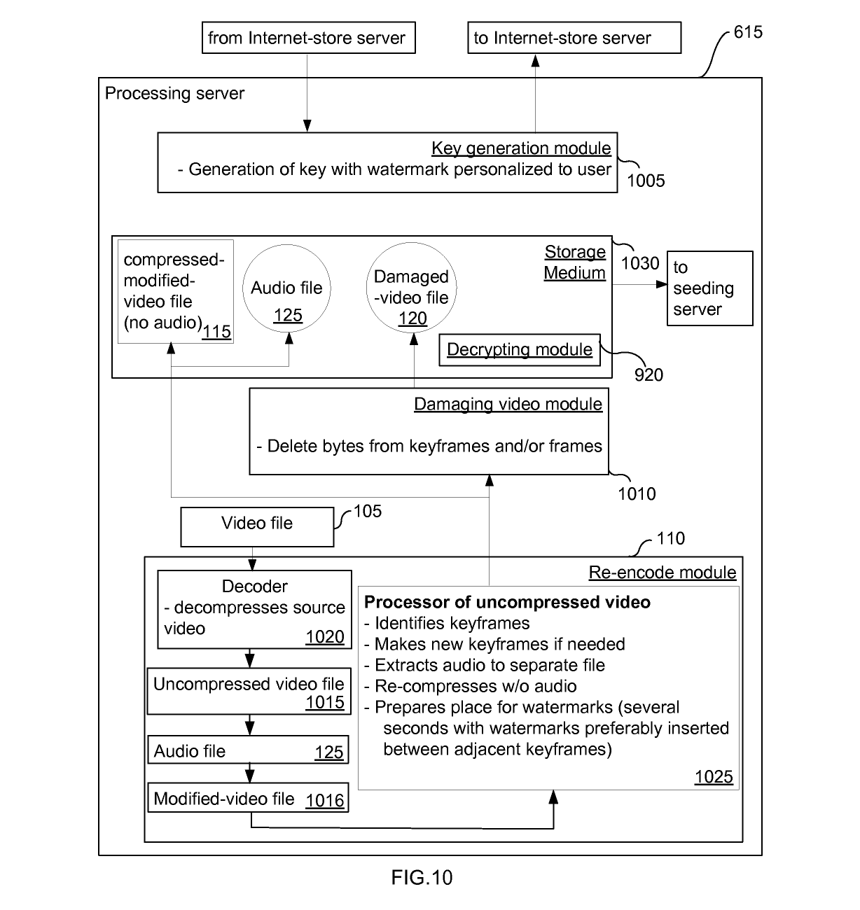

FIG. 10 illustrates operations performed by in the processing server (615). The components the processing server (615) are a key generation module (1005); a damaging video module (1010); a re-encode module (110), which includes a decoder (1020) and a processor of uncompressed video (1025); a storage medium (1030), which is a non-transitory computer readable storage device.

In the re-encode module (110), the decoder (1020) may implement a step of decompressing the video file to produce an uncompressed-video file (1015). The video file (105) is the source file. Effectively, each frame in an uncompressed-video file (1015) becomes a keyframe and is independent. So, when performing the optional step of decompressing the video file, the decompressing step converts dependent frames to keyframes. Then, when re-compressing, additional keyframes may be placed at any required locations to support the watermark.

When the decompressing step is performed, the processor of uncompressed video (1025) then acts on the uncompressed-video file (1015) from the decoder (1020) by extracting audio from the uncompressed-video file (1015). The extracted audio is an undamaged audio stream in an audio file (125). The produced or resulting files are: an uncompressed-video file (1015) without audio, termed a modified-video file (1016); and an audio file (125).

The processor of uncompressed video (1025) then acts by compressing the modified-video file (1016). The file resulting from the compression is a clean video stream called a compressed-modified-video file (115), which is a compressed video without audio.

The processor of uncompressed video (1025) then prepares the compressed-modified-video file for later insertion of a watermark (130) at a randomized location on the compressed-modified-video file (115). This is done by detecting the location of keyframes in the compressed-modified-video file. Preferably, a watermark is a randomly generated unique 16-char string. The watermark may include any alphanumeric character. Preferably, the watermark is added to the file at roughly equal intervals in short bursts, with some randomization added to prevent formation of regular, easily-detected pattern. For example, the watermark may be added in two-second segments of a video file every two minutes with the period between segments randomized with a mean difference of several seconds.

Keyframes are video frames, which are coded without any reference to pictures except themselves. In the field of video compression, a video frame is compressed using different algorithms with different advantages and disadvantages, centered mainly around amount of data compression. These different algorithms for video frames are called frame types. The three major frame types used in most common video compression algorithms are I, P and B.

I-frames are standalone pictures that do not require other video frames to decode. P-frames and B-frames can use data from other frames to decompress and are more compressible than I-frames. In more basic terms, video compression software will store entire images in certain frames, showing only changes in frames after that. By removing arbitrary bytes from the keyframes, the keyframes are damaged and can't easily be reconstructed. As the following frames contain differences from the preceeding keyframe, if the keyframe is damaged, then the following frames cannot be reconstructed.

Bytes may optionally be removed from other frames or parts of the video besides the keyframes.

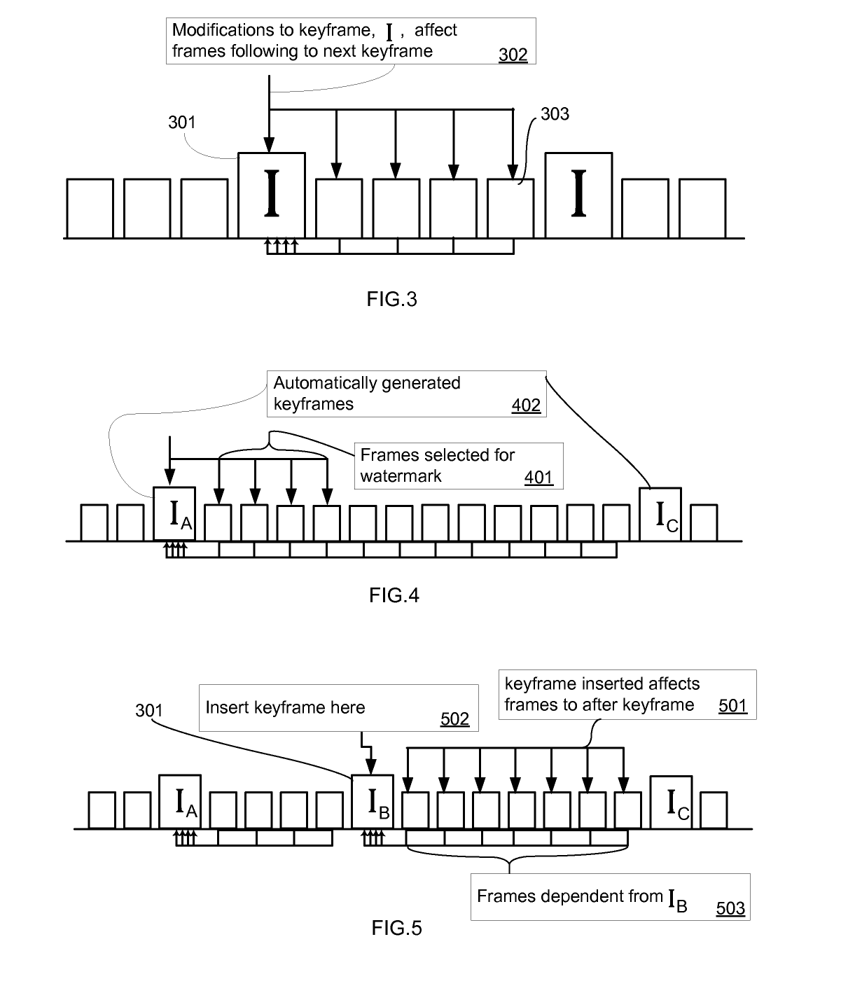

The keyframe and frame relationship in a video file is illustrated in FIG. 3, FIG. 4 and FIG. 5. These figures show a representative sample of a video file with keyframes (larger boxes) and frames (smaller boxes) between the keyframes.

FIG. 3 shows a keyframe (301), a frame (303) and that “modifications to keyframe, I_{B}, affect frames following to next keyframe” (302)

FIG. 4 illustrates “frames selected for watermark” (401); keyframes identified or “automatically generated keyframes” (402); and keyframes added by the re-encode module (110).

It is sometimes necessary to create one or more keyframes in the compressed-modified-video file. This occurs where the range of frames between generated keyframes is larger than the number of frames to be watermarked. If that is the case, then, preferably, a keyframe is generated by the re-encode module (110) just after the last frame sought to be watermarked.

FIG. 5 illustrates the re-encode module (110) optionally adding, that is inserting, a keyframe (301) into the compressed-modified-video file (115). This is done if an additional keyframe or more is needed to support the addition of a watermark (130). This is an optional step of adding a keyframe (301), designated I_{B}, and is identified as “insert keyframe here” (502). FIG. 5 illustrates that the “keyframe inserted affects frames to after keyframe” (501) and up to the next keyframe, designated l_{c}. The affected frames are shown by the brace designated by the box “frames dependent from I_{B}” (503). Later when a user (200) decides to buy a key to restore a damaged video, the key generation module (1005) will add a watermark to the file which identifies the buyer or user (200). The addition of a watermark creates a watermarked-modified-video file (135). Preferably, a plurality of watermarks is added to the file to ensure that the watermark cannot easily be erased or circumvented. Each watermark (130) is preferably inserted between two keyframes.

The key generation module (1005) implements a step of combining the watermarked-modified-video file (135) with the audio file (125) to create a watermarked-movie file (140), which is a fully operational movie having a watermark identifying the buyer or user (200).

The compressed-modified-video file (115), that is the compressed video without audio, is sent to the damaging video module (1010) to create a damaged-video file (120) by removing bytes to make the compressed-modified-video file (115) unplayable. The damaging video module (1010) produces a damaged-video file (120) that is a video stream without important or necessary parts for playing the video file (120). The damaging video module (1010) implements an action comprising removing a first portion of the bytes arbitrarily selected from keyframes (preferably all, or randomly selected keyframes) in the plurality of keyframes of the compressed-modified-video file to make the keyframes, with the first portion of the bytes removed, unreadable by a video player. The damaging video module (1010) may also remove bytes from a frame (303) of the compressed-modified-video file (115). In that case, the damaging video module (1010) will implement a step of removing a second portion from the bytes selected from the frames of a video file. Preferably, the damaged-video file (120) is a media file with bytes removed and the file encrypted and compressed in such a manner that it cannot be reconstructed without knowledge of the content of the original video file.

Once the damaged-video file (120) is created, it is preferably recombined with the audio file (125). However, it is not essential to combine the damaged-video file (120) with the audio file (125). Recombining the damaged-video file (120) with the audio file (125) permits maximizing the operable components in the damaged-video file (120), so that the key (150) has a relative small byte size when it comes time to send it to the user (200). Preferably, the damaged-video file (120) contains about 95% of a playable movie. Thus, the size of the key (150) is preferably the remaining 5 percent, which can be downloaded in a reasonable time after payment. The key (150) applied to a four gigabyte public ISO file could be as large as 100-200 megabytes.

The computer (611) may comprise a seeding server (620), which is responsible for distributing or seeding the damaged-video file (120) to the public. Seeding is preferably done via a BITTORRENT network of peers (625) or multiple users' computers.

To foster distribution of the damaged-video file (120), the method may include the steps of: creating a public ISO file (145) comprising the damaged-video file (120) and the audio file (125); and distributing the public ISO file (145) for access by the user (200). Optionally, the computer (611) may implement step of: creating a public ISO file using an XOR cipher, the public ISO file comprising the damaged-video file and the audio file.

A damaged-video file may be encrypted with a unique cipher before it is packed in an ISO file. Such encryption would protect the video from extraction from the ISO file. For example, any of the following encryption methods may be used in the generation of the ISO file: removing from keyframes information for frame unpacking, such as removing the variable-length code table of Huffman coding; removing an arbitrary part from random keyframes; and applying an XOR cipher to the entire file.

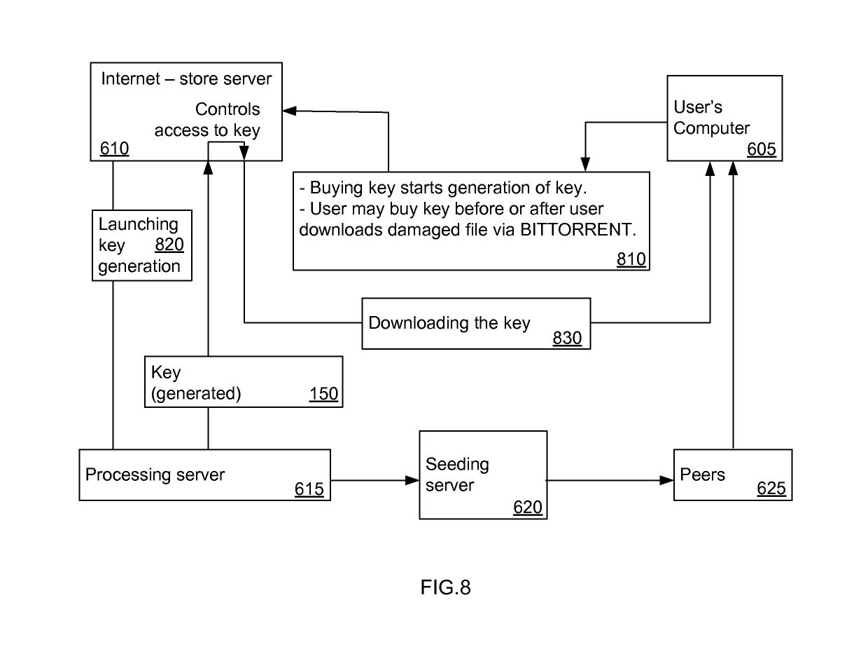

FIG. 8 illustrates the steps involved in creating a key (150). The process starts when a user (200) decides to purchase a key (150) to make a damaged-video file (120) operable. Deciding to purchase a key (150) is preferably initiated on a user's computer (605), but may be done by the user (200) visiting a brick and mortar store connected to the processing server (615). FIG. 8 illustrates buying from a user's computer (605): “—Buying key starts generation of key. —User may buy key before or after user downloads damaged file via BITTORRENT” (810). Buying a key (150) is typically done through an “Internet—store server” (610), which ultimately sells the key (150) and controls access to the computer (611) or processing server (615) that generates the key (150). The user (200) typically requests the key (150) and the computer (611) ultimately implements a step of receiving the request for the key (150) to restore the damaged-video file (120) to the watermarked-movie file (140). The user (200) typically obtains the key by “downloading the key” (830) from the “Internet—store server” (610).

The “Internet—store server” (610) initiates a step of “launching key generation” (820) by sending user information to the processing server (615), which is used in watermarking the compressed-modified-video file (115).

The computer (611) preferably through the processing server (615) implements a step of creating a key (150) used to restore the damaged-video file (120) to the watermarked-movie file (140), said key (150) comprising the difference between the watermarked-movie file (140) and the damaged-video file (120). The key (150) may be considered a difference file that contains a series of instructions to insert a series of bytes into the damaged-video-file to get a playable watermarked-movie.

The key (150) may itself be made operable to run on the user's computer (605) to restore the damaged-video file (120) to a watermarked-movie file (140). The damaged-video file (120) is typically in the possession of the user (200) and accessible on the user's computer (605).

Alternatively, the key (150) may be used by a separate program or decrypting module (920) made available to a user (200) for running on the user's computer (605) to use the key to make the damaged-video file (120) viewable by the user (200). The decrypting module (920) is preferably held in the storage medium (1030) on the computer (611). The decrypting module (920) is a program, which is downloaded by user, preferably from the seeding server (620), and then it stored and executed on the user's computer (605). Programming instructions for executing the algorithms and systems described herein are also preferably held in the storage medium (1030). Such storage is preferably a non-transitory computer readable medium.

The computer (611) then seeds or distributes the decrypting module (920) preferably using the seeding server (620) connected to the peers (625) using the BITTORRENT network. For example, when a first user requests the decrypting module (920), it is preferably downloaded from the seeding server (620) or an Internet—store server (610). As other users (peers) download the decrypting module (920), those peers who have already downloaded the decrypting module (920), participate in the download process from yet other users, speeding up the download process.

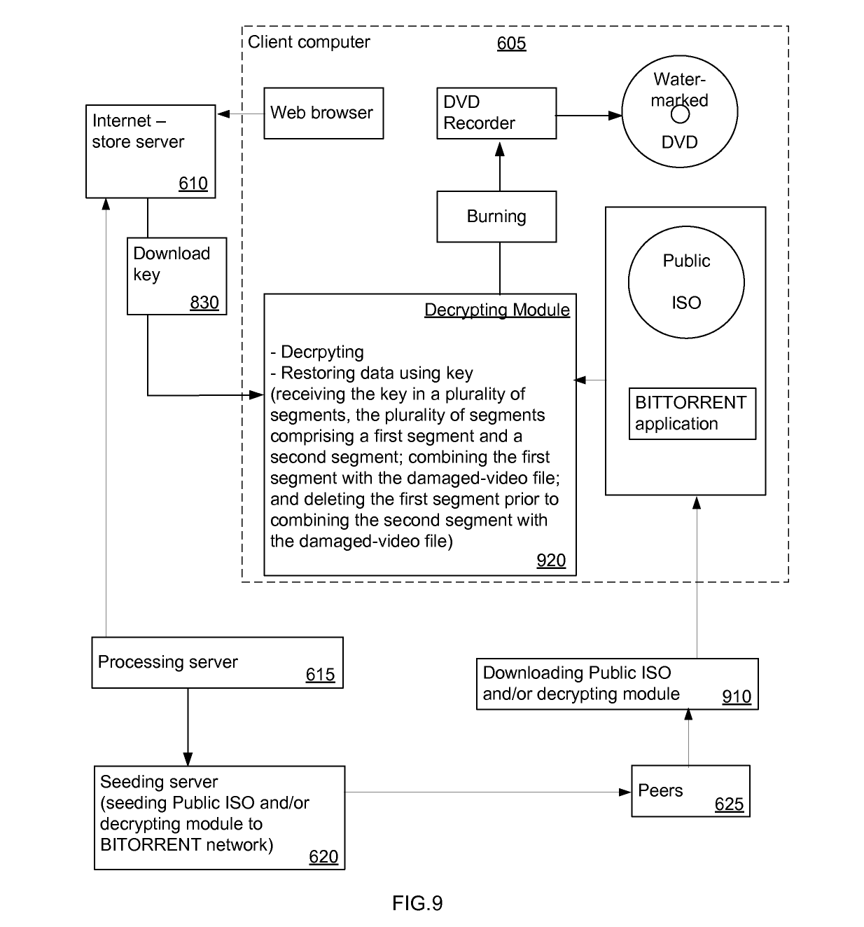

Thus, the user (200) accesses it via the BITTORRENT network. This is indicated in FIG. 9 by “Downloading Public ISO and/or decrypting module” (910).

Alternatively, the key (150) may be used to add the watermark (130) to the damaged-video file (120). In this embodiment, the watermark (130) is added onto the damaged-video file (120) as it is being burned onto a DVD as part of the download and use of the key (150).

When a key is used to add the watermark, the process is altered in that no watermark is added to the compressed-modified-video file (115) by the processing server. So, no watermarked-modified-video file (135) is produced. Instead, the key (150) is prepared to include the watermark (130) when restoring the damaged-video file (120). Thus, this method producing a damaged-video file (120) uses the same first three steps as described above and alters the remaining steps accordingly.

When the key (150) is used to add the watermark (130) to the damaged-video file (120), the method remains one for deterring theft of a video file (105), the video file (105) comprising audio and bytes of data organized in keyframes and frames. The method is still performed on a computer (611) coupled to a network (640). And the computer (611) implements actions comprising the steps of: decompressing the video file (105) to produce a uncompressed-video file (1015); extracting audio from the uncompressed-video file (1015) to produce a modified-video file (1016) and an audio file (125); detecting a plurality of keyframes in the modified-video file (1016); compressing the modified-video file (1016) to produce a compressed-modified-video file (115); producing a damaged-video file (120) by implementing an action comprising removing a first portion of the bytes arbitrarily selected from at least two keyframes in the plurality of keyframes of the compressed-modified-video file to make the keyframes with the first portion of the bytes removed unreadable by a video player; combining the compressed-modified-video file (115) with the audio file (125) to create a personal movie (207), which may be referred to as a non-watermarked movie; creating a key (150) used to change the damaged-video file (120) to the personal movie (207), said key (150) comprising: the difference between the personal movie (207) and the damaged-video file (120); and a watermark (130), the watermark (130) inserted by the key at a randomized location on the damaged-video file (120); and the key (150) when used creates an operable watermarked-movie file (140); and sending the key (150) to a user so that the user can change the damaged-video file (120) to the operable watermarked-movie file (140).

To enhance security, the program, that is the decrypting module (920), when run on the user's computer (605) preferably implements steps of receiving the key in a plurality of segments, the plurality of segments comprising a first segment and a second segment; combining the first segment with the damaged-video file; and deleting the first segment prior to combining the second segment with the damaged-video file. In this way, the key (150) is never available as an entire file, thus preventing any user from copying the key for use by others. The key (150) may be stored in Random Access Memory (RAM) so that the segments are readily deleted after they applied. The key (150) may also be transferred from the seeding server to user's computer (605) using a secure protocol, such as Transport Layer Security (TLS) or its predecessor, Secure Sockets Layer (SSL), also known as an SSL/TLS encrypted protocol.

Once the key (150) is prepared, the computer (611) implements a step of sending the key (150) to the user (200) so that the user (200) can restore the damaged-video file (120) to the watermarked-movie file (140). Sending is typically accomplished by the user (200) “downloading the key” (830) from the “Internet—store server” (610). An Internet store server accepts orders from users, also referred to herein as customers, for a key used to decrypt a video file. Preferably, the Internet store server has a plurality of such keys, video files and customers. The Internet store enables download or delivery to customers of a damaged-video file (120).

The device or system for implementing the methods described herein includes the computer (611). The computer (611) may include a collection of servers and associated computer hardware to enable use and operation of the computer (611). Each such server is connected to the network (630), each such server having one or more storage devices comprising a non-transitory computer readable medium and one or more interactive input devices. These input devices may include but are not limited to a mouse, keyboard and webcam.

The computer (611) is preferably organized in modules. The modules include: a re-encode module (110); a key generation module (1005); and a damaging video module (1010).

The re-encode module (110) is coupled to the computer and performs the steps, described above, which include: optionally decompressing the video file (105) to produce a uncompressed-video file (1015); extracting audio from the video file, or the uncompressed-video file (1015), to produce a modified-video file (1016) and an audio file (125); detecting a plurality of keyframes in the modified-video file (1016); and when the optional step of decompressing the video file is performed, then compressing the modified-video file (1016) to produce a compressed-modified-video file (115).

The key generation module (1005) is coupled to the computer, the key generation module and performs the steps, described above, which include: inserting a watermark at a randomized location on the compressed-modified-video file, said watermark is preferably inserted between two keyframes to create a watermarked-modified-video file; and creating a key operable to restore the damaged-video file to the watermarked-movie file, said key comprising the difference between the watermarked-movie file and the damaged-video file.

The damaging video module (1010) is coupled to the computer and performs the step, described above, which includes removing a first portion of the bytes arbitrarily selected from at least two keyframes in the plurality of keyframes of the compressed-modified-video file to make the keyframes with the first portion of the bytes removed unreadable by a video player, thereby producing the damaged-video file (120).

### Example 1

A system delivering the best performance might include a processing server comprising: three re-encoder servers for simultaneous generation of compressed-modified-video files; 15 key generation servers for faster parallel generation of keys; a separate storage server for the files, such as compressed-modified-video files, damaged-video files, audio files, and modules; and at least one seeding server (620) for web storage. The seeding server (620) preferably participates in the download process when enough peers (625) are not available.

### Example 2

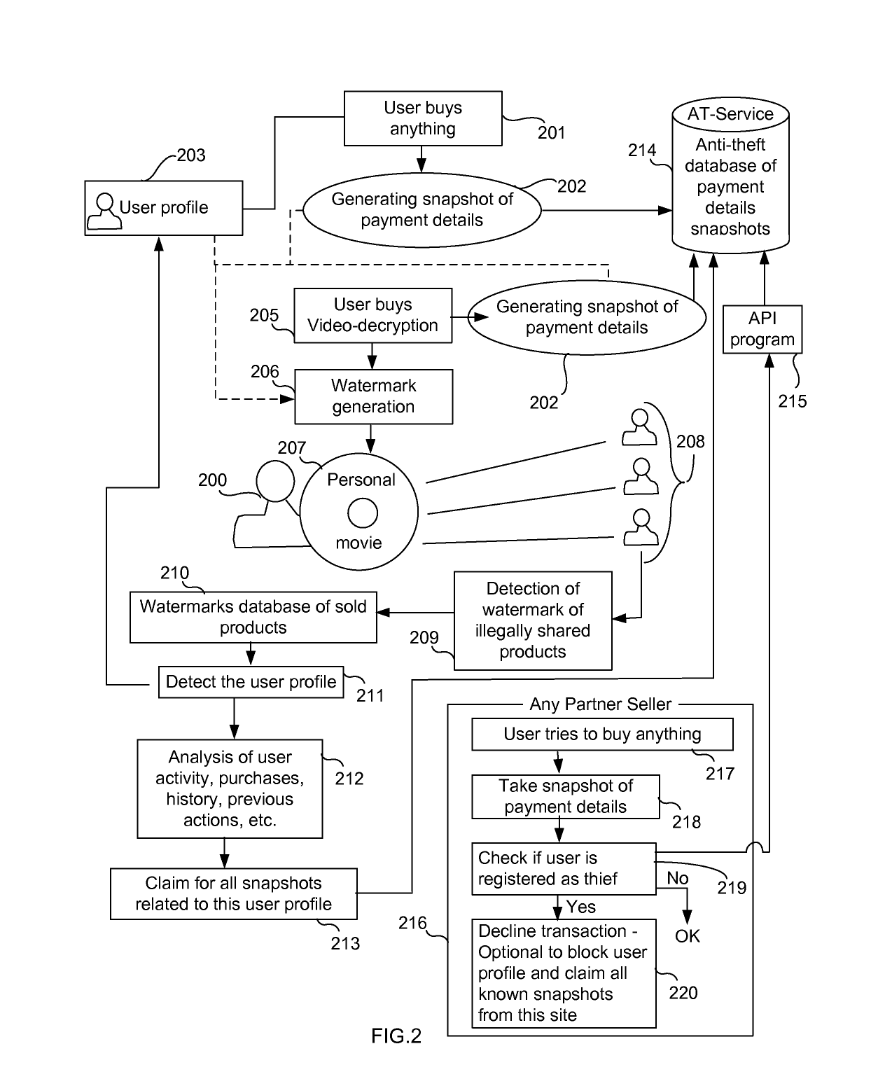

FIG. 2 illustrates an example of the system employing a user profile (203), which is created whenever the “user buys anything” (201) in the network (630). The network (630) is preferably a public network, such as the Internet. The Internet—store server (610) implements a step of “generating snapshot of payment details” (202). The snapshot is taken when the “user buys Video-decryption,” (205), also known as the key (150). The snapshot details are preferable stored in an “anti-theft database of payment details snapshots” (214). The user profile (203) is used for “watermark generation” (206) in the creation of a key (150) for that user's “personal movie” (207). If the user (200) transfers his “personal movie” (207) to third parties (208) the watermark alerts the third parties (208) that it is a “personal movie” (207) belonging to another, that is, that the “personal movie” (207) may be pirated. Once any of the third parties (208) reports the potentially pirated file, the “personal movie” (207) can be examined for “detection of watermark of illegally shared products” (209). Then, the actions by the user (200) for whom the “personal movie” (207) was created can be monitored to determine if the file was stolen from the user (200) or if the user (200) is a pirate.

In this example, the issued watermark (130) is stored in a “watermarks database of sold products” (210), which is consulted to “detect the user profile” (211). The user profile (203) enables an “analysis of user activity, purchases, history, previous actions, etc.” (212) and a “claim for all snapshots related to this user profile” (213) is made to the “anti-theft database of payment details snapshots” (214) to better understand the history with that user (200). Whenever a “user tries to buy anything” (217) from “any partner seller” (216) that seller “take snapshot of payment details” (218) and runs an “API program” (215), which is an application program interface to check the “anti-theft database of payment details snapshots” (214) and “check if user is registered as thief” (219). If that user is in the “anti-theft database of payment details snapshots” (214), then the seller may “Decline transaction or optionally block the user profile and claim all known snapshots from this site” (220). If the user is not in the “anti-theft database of payment details snapshots” (214), then the seller may proceed with the sale.

Any of the steps described herein are useful machine operations and relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of MICROSOFT WINDOWS, APPLE MAC, UNIX/X-WINDOWS, LINUX, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any non-transitory computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

Other computer system configurations consistent with implementing the steps disclosed herein may be used, including hand-held devices, microprocessor systems, microprocessor-based or programmable consumer electronics, minicomputers, mainframe computers and the like. Distributing computing environments may be employed where one or more of the steps disclosed herein are performed by remote processing devices that are linked through a network.

A computer readable code stored on a non-transitory computer readable medium is preferably implemented by a computer to implement the steps disclosed herein. The computer readable medium is any data storage device, preferably providing non-transitory storage, that can store data, which can thereafter be read by a computer system. Examples of the computer readable medium include hard drives, network attached storage (NAS), read-only memory (ROM), random-access memory (RAM), Compact Disc-Read Only Memory (CD-ROM), Compact Disc-Recordable (CD-R), Compact Disc-Re-Writable (CD-RW), Digital Video Disc (DVD), flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

### INDUSTRIAL APPLICABILITY

The invention has application to the movie and video industries.

What is claimed is:

1. A method for deterring theft of a video file, the video file comprising bytes of data organized in a video stream, the video stream comprising keyframes and frames, and further organized in an audio stream, the method performed on a computer coupled to a network, the method comprising the steps of:
producing a damaged-video file by implementing an action comprising removing a portion of the bytes from the video file to make the video file unplayable;
inserting a watermark at a randomized location on the video file to create a watermarked-movie file;
creating a key used to restore the damaged-video file to the watermarked-movie file, said key comprising the difference between the watermarked-movie file and the damaged-video file; and
sending the key to a user so that the user can restore the damaged-video file to the watermarked-movie file.

2. A method for deterring theft of a video file, the video file comprising bytes of data organized in a video stream, the video stream comprising keyframes and frames, and further organized in an audio stream, the method performed on a computer coupled to a network, the method comprising the steps of:
producing a damaged-video file by implementing an action comprising encrypting the video file to make the video file unplayable;
inserting a watermark at a randomized location on the video file to create a watermarked-movie file;
creating a key used to restore the damaged-video file to the watermarked-movie file, said key comprising the difference between the watermarked-movie file and the damaged-video file; and
sending the key to a user so that the user can restore the damaged-video file to the watermarked-movie file.

3. A system for implementing the method of claim 1, the system comprising:
a computer coupled to a network, the computer comprising a non-transitory computer readable storage medium;
a re-encode module coupled to the computer, the re-encode module performing the steps of:
extracting audio from the video file to produce a modified-video file and an audio file; and
detecting a plurality of keyframes in the modified-video file;
a key generation module coupled to the computer, the key generation module performing the steps of:
inserting a watermark at a randomized location on the compressed-modified-video file to create a watermarked-modified-video file; and
creating a key operable to restore the damaged-video file to the watermarked-movie file, said key comprising the difference between the watermarked-movie file and the damaged-video file; and
a damaging video module coupled to the computer, the damaging video module performing the step of removing a first portion of the bytes arbitrarily selected from at least two keyframes in the plurality of keyframes of the compressed-modified-video file to make the keyframes with the first portion of the bytes removed unreadable by a video player, the damaging video module producing a damaged-video file.

4. A method for deterring theft of a video file, the video file comprising bytes of data organized in an video stream, the video stream comprising keyframes and frames and further organized in an audio stream, the method performed on a computer coupled to a network, the method comprising the steps of:
decompressing the video file to produce a uncompressed-video file;
extracting audio from the uncompressed-video file to produce a modified-video file and an audio file;
detecting a plurality of keyframes in the modified-video file;
compressing the modified-video file to produce a compressed-modified-video file;
inserting a watermark at a randomized location on the compressed-modified-video file to create a watermarked-modified-video file;
producing a damaged-video file by implementing an action comprising removing a first portion of the bytes arbitrarily selected from at least two keyframes in the plurality of keyframes of the compressed-modified-video file to make the keyframes with the first portion of the bytes removed unreadable by a video player;
combining the watermarked-modified-video file with the audio file to create a watermarked-movie file;
creating a key used to restore the damaged-video file to the watermarked-movie file, said key comprising the difference between the watermarked-movie file and the damaged-video file; and
sending the key to a user so that the user can restore the damaged-video file to the watermarked-movie file.

5. The method of claim 4, further comprising the step of adding a keyframe to the modified-video file.

6. The method of claim 4, where the action in the step of producing a damaged-video file further comprises removing a second portion from the bytes selected from the frames.

7. The method of claim 4, further comprising the steps of:
creating a public ISO file comprising the damaged-video file and the audio file; and
distributing the public ISO file for access by the user.

8. The method of claim 4, further comprising the step of creating an public ISO file using an XOR cipher, the public ISO file comprising the damaged-video file and the audio file.

9. The method of claim 4, further comprising the step of receiving a request for a key to restore the damaged-video file to the watermarked-movie file.

10. The method of claim 4, further comprising the step of creating a program stored on a non-transitory computer readable medium, the program operable to incrementally restore the damaged-video file to the watermarked-movie file in actions comprising:
receiving the key in a plurality of segments, the plurality of segments comprising a first segment and a second segment;
combining the first segment with the damaged-video file; and
deleting the first segment prior to combining the second segment with the damaged-video file.
